(19) United States
(12) Patent Application Publication
(10) Pub. No.: US 2019/0075223 A1
(43) Pub. Date: Mar. 7, 2019

(54) CAMERA MODULE AND ASSEMBLING METHOD THEREOF

(71) Applicant: Primax Electronics Ltd., Taipei (TW)

(72) Inventor: Shu-Ying Chen, Taipei (TW)

(21) Appl. No.: 15/830,618

(22) Filed: Dec. 4, 2017

(30) Foreign Application Priority Data
Sep. 1, 2017 (TW) 106130015

(51) Int. Cl. H04N 5/225; G02B 7/02

(52) U.S. Cl. CPC H04N 5/2252; G02B 7/02; H04N 5/2253; H04N 5/2254

(57) ABSTRACT

A camera module includes a substrate, a sensing chip, an electronic component, a base plate and a lens module. The sensing chip is disposed on a first surface of the substrate. The electronic component is disposed on a second surface of the substrate. The base plate covers the second surface of the substrate. The base plate includes an opening. The electronic component is received within the base plate through the opening. The lens module covers the first surface of the substrate. Since the electronic component is installed on the second surface of the substrate, the electronic component is not covered by the lens module. Since the substrate with small volume is used in the camera module, the volume of the camera module is reduced.

### FIELD OF THE INVENTION

The present invention relates to a camera module, and more particularly to a camera module for a portable electronic device.

### BACKGROUND OF THE INVENTION

Recently, mobile communication devices, personal digital assistants (PDA) or other portable electronic devices with image-shooting functions are widely used. Since the portable electronic devices can be carried easily, the image-shooting functions become the basic functions of the portable electronic devices. In other words, the portable electronic device is equipped with a camera module.

The structure of a conventional camera module will be illustrated with reference to FIGS. 1 and 2. FIG. 1 is a schematic perspective view illustrating the outward appearance of a conventional camera module. FIG. 2 is a schematic cross-sectional view illustrating the conventional camera module. As shown in FIGS. 1 and 2, the camera module 1 comprises a casing 10, a sensing element 11, a lens module 12 and plural electronic components 13. The sensing element 11 may receive an external light beam L outside the camera module 1 and produce an image. The sensing element 11 comprises a sensing chip 111 and a circuit board 112. The sensing chip 111 is fixed on the circuit board 112. The sensing chip 111 is used for receiving the external light beam L and producing the image. The sensing chip 111 has a sensing region 1111. The circuit board 112 is connected with the sensing chip 111 and the lens module 12. The sensing chip 111 is supported by the circuit board 112.

Please refer to FIGS. 1 and 2. The sensing element 11 is covered by the lens module 12. After the external light beam L passes through the lens module 12, the external light beam L strikes the sensing region 1111 of the sensing element 11. The lens module 12 comprises a lens assembly 121 and a lens holder 122. The lens assembly 121 is located over the sensing chip 111 and aligned with the sensing chip 111. The lens holder 122 is used for supporting the lens assembly 121 and covering the circuit board 112. In addition, the lens holder 122 is connected with the circuit board 112. The plural electronic components 13 are disposed on the circuit board 112. Moreover, the plural electronic components 13 are covered by the lens holder 122 and disposed within the lens module 12. The casing 10 is used for sheltering the lens module 12 in order to avoid damage of the lens module 12. The above components are combined together, and thus the camera module 1 is assembled. After the external light beam L passes through the lens assembly 121 and strikes the sensing region 1111 of the sensing chip 111, the sensing chip 111 produces the corresponding image.

With increasing development of science and technology, the user pays much attention to the image-shooting function of the portable electronic device and demands the portable electronic device with reduced volume. However, as the volume of the portable electronic device is reduced, the space inside the portable electronic device is reduced. In other words, it is difficult to install the camera module in the portable electronic device. Moreover, as the demands on the high performance camera module are gradually increased, it is also difficult to reduce the volume of the portable electronic device. For example, in case that the volume of the circuit board 12 is reduced, the volume of the camera module 1 can be reduced. However, since the plural electronic components 13 are disposed on the circuit board 112, the volume of the circuit board 112 cannot be reduced.

Therefore, there is a need of providing a camera module with reduced volume.

### SUMMARY OF THE INVENTION

An object of the present invention provides a camera module with reduced volume.

Another object of the present invention provides an assembling method of the camera module.

In accordance with an aspect of the present invention, there is provided a camera module. The camera module includes a substrate, a sensing chip, an electronic component, a base plate and a lens module. The sensing chip is disposed on a first surface of the substrate and electrically connected with the substrate. The electronic component is disposed on a second surface of the substrate. The base plate covers the second surface of the substrate. The base plate includes an opening. The electronic component is received within the base plate through the opening. The lens module covers the first surface of the substrate. Moreover, the electronic component is not covered by the lens module.

In accordance with another aspect of the present invention, there is provided a camera module. The camera module includes a substrate, a sensing chip, a lens module and a glue. The sensing chip is disposed on a first surface of the substrate. The sensing chip includes a welding part. The welding part is electrically connected with the substrate. The lens module covers the first surface of the substrate. The lens module includes a concave structure. The welding part is accommodated within the concave structure. The glue is arranged between the concave structure and the substrate. A portion of the welding part is covered by the glue. Moreover, a space between the lens module and the substrate is sealed by the glue.

In accordance with a further aspect of the present invention, there is provided an assembling method of a camera module. The assembling method includes the following steps. Firstly, an electronic component is installed on a second surface of a substrate. Then, the second surface of the substrate is covered by a base plate. Then, a sensing chip is installed on a first surface of the substrate. Then, the first surface of the substrate is covered by a lens module. Consequently, the camera module is assembled.

From the above descriptions, the present invention provides an assembling method of a camera module. In accordance with the present invention, the plural electronic components are installed on the second surface of the substrate. In comparison with the conventional technology of installing the electronic components on the first surface of the substrate, the substrate used in the camera module of the present invention has smaller volume. Since the volume of the camera module is reduced, the camera module is slim. Moreover, in the assembling method of the present invention, the glue is coated in the gap between the lens holder and the substrate to seal the lens holder and the substrate. Moreover, since the sensing chip is partially covered by the glue, the electric connection between the substrate and the sensing chip is stabilized.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional camera module;

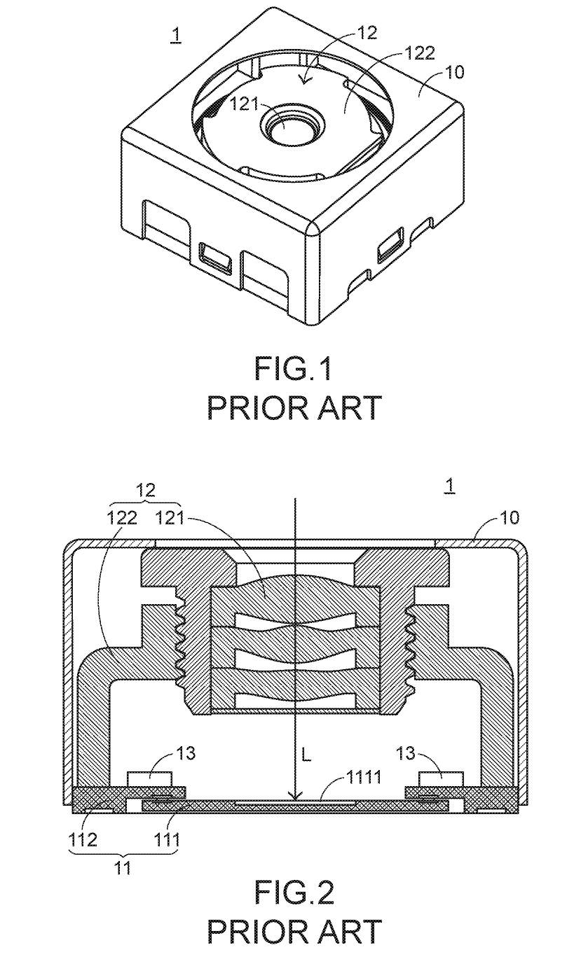

FIG. 2 is a schematic cross-sectional view illustrating the conventional camera module;

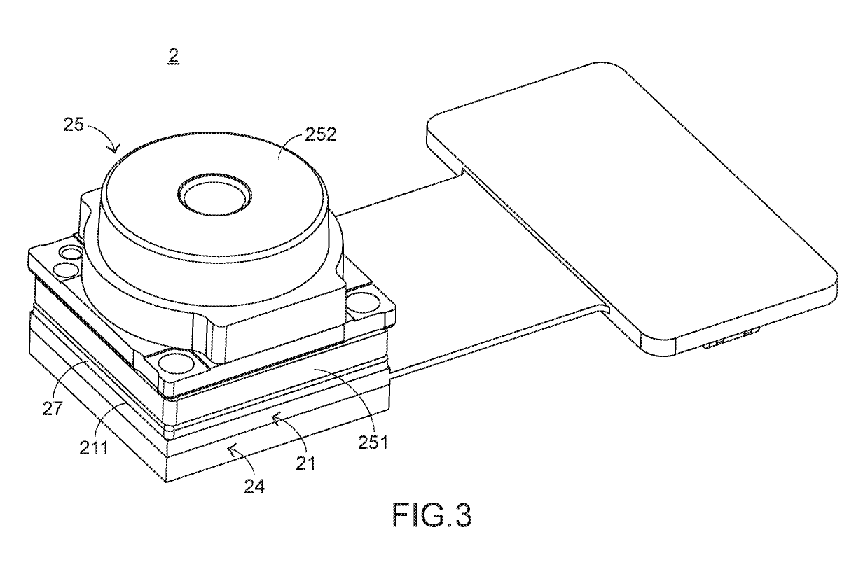

FIG. 3 is a schematic perspective view illustrating the outward appearance of a camera module according to an embodiment of the present invention;

FIG. 4 is a schematic perspective view illustrating the outward appearance of the camera module of FIG. 3 and taken along another viewpoint;

FIG. 5 is a schematic cross-sectional view illustrating the structure of the camera module according to the embodiment of the present invention;

FIG. 6 is a flowchart illustrating an assembling method of a camera module according to an embodiment of the present invention;

FIGS. 7A˜7D schematically illustrate the steps of assembling the camera module of the present invention; and

FIG. 8 is a flowchart illustrating an assembling method of a camera module according to another embodiment of the present invention.

### DETAILED DESCRIPTION OF THE PREFERRED EMBODIMENT

For solving the drawbacks of the conventional technology, the present invention provides a camera module and an assembling method of the camera module. The structure of the camera module of the present invention will be illustrated as follows.

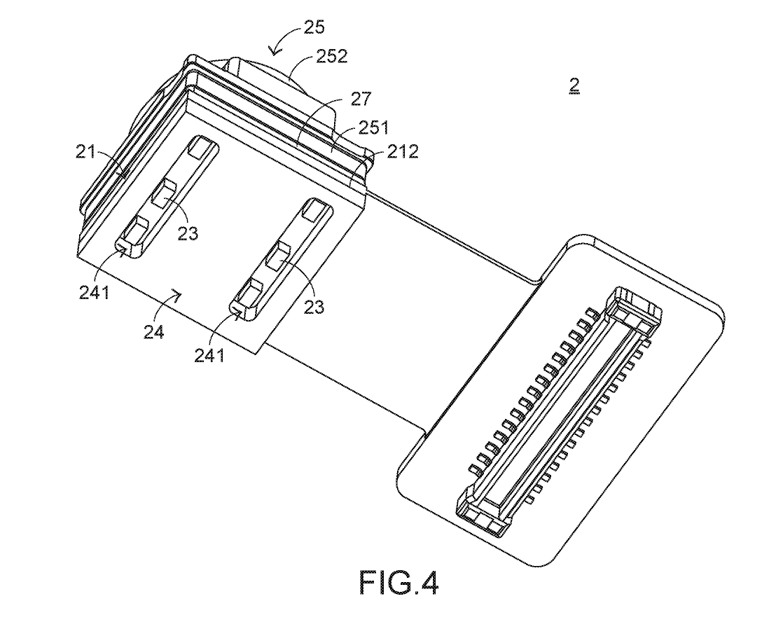

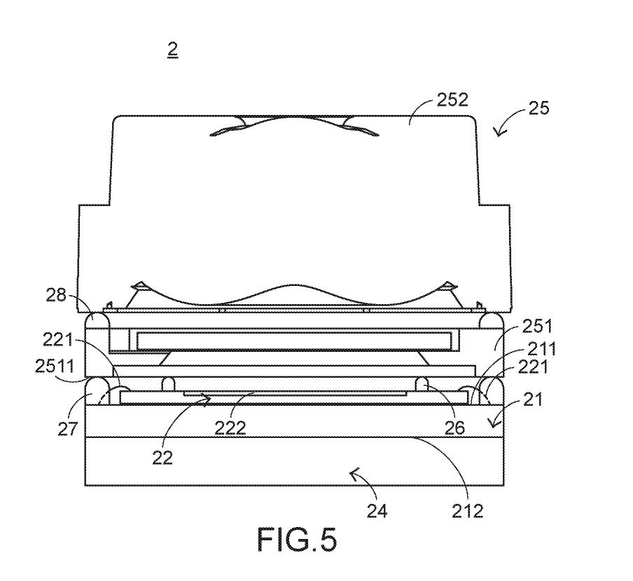

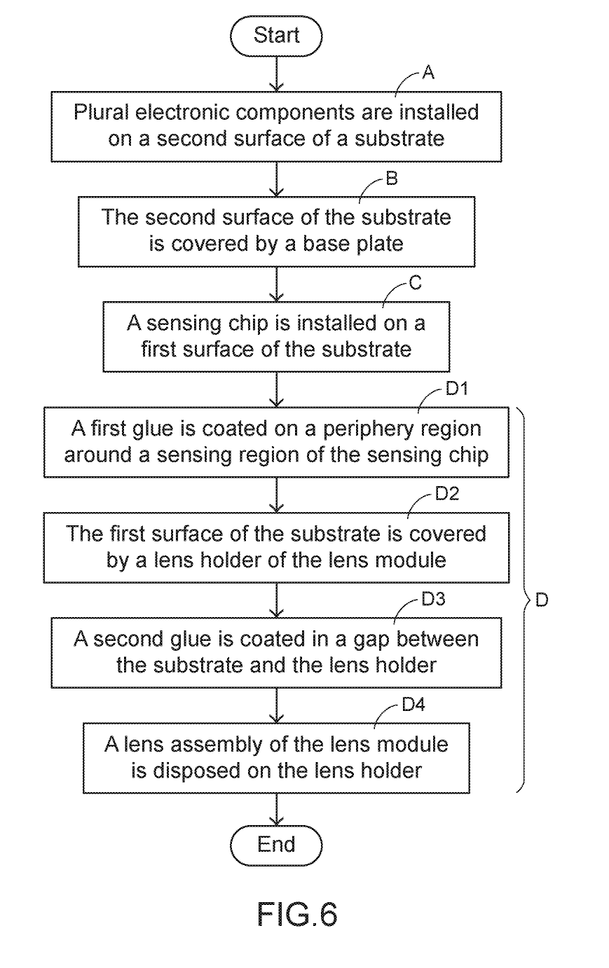

Please refer to FIGS. 3, 4 and 5. FIG. 3 is a schematic perspective view illustrating the outward appearance of a camera module according to an embodiment of the present invention. FIG. 4 is a schematic perspective view illustrating the outward appearance of the camera module of FIG. 3 and taken along another viewpoint. FIG. 5 is a schematic cross-sectional view illustrating the structure of the camera module according to the embodiment of the present invention. The camera module 2 comprises a substrate 21, a sensing chip 22, plural electronic components 23, a base plate 24 and a lens module 25. The sensing chip 22 is disposed on a first surface 211 of the substrate 21 and electrically connected with the substrate 21. The sensing chip 22 comprises plural welding parts 221 and a sensing region 222. The plural welding parts 221 are bonding wires. The sensing chip 22 is electrically connected with the substrate 21 through the plural welding parts 221. The plural electronic components 23 are disposed on a second surface 212 of the substrate 21 and electrically connected with the substrate 21. The second surface 212 of the substrate 21 is covered by the base plate 24. Moreover, the base plate 24 comprises plural openings 241. The plural electronic components 23 received within the base plate 24 through the openings 241. In an embodiment, the substrate 21 is a rigid-flex board, a FR4 copper clad laminate or a ceramic substrate.

The lens module 25 is located over the substrate 21 to cover the first surface 211 of the substrate 21. Consequently, the sensing chip 22 is sealed between the lens module 25 and the substrate 21. Since the plural electronic components 23 are disposed on a second surface 212 of the substrate 21, the plural electronic components 23 are not covered by the lens module 25. The lens module 25 comprises a lens holder 251 and a lens assembly 252. The lens holder 251 covers the first surface 211 of the substrate 21. The lens assembly 252 is supported on the lens holder 251. The lens holder 251 comprises plural concave structures 2511. The concave structures 2511 are formed in a bottom surface of the lens holder 252. The welding parts 221 are accommodated within the corresponding concave structures 2511. In this embodiment, the lens assembly 252 comprises plural lenses.

The camera module 2 further comprises a first glue 26, a second glue 27 and a third glue 28. The first glue 26 is coated on a periphery region around the sensing region 222 of the sensing chip 26. The sensing chip 22 and the lens holder 251 are combined together through the first glue 26. The second glue 27 is arranged between the plural concave structures 2511 and the substrate 21. Moreover, portions of the welding parts 221 are covered by the second glue 27. Consequently, the welding parts 221 are securely fixed by the second glue 27. In addition, the space between the lens holder 251 and the substrate 21 is sealed by the second glue 27. The third glue 28 is arranged between the lens holder 251 and the lens assembly 252. The lens holder 251 and the lens assembly 252 are combined together through the third glue 28.

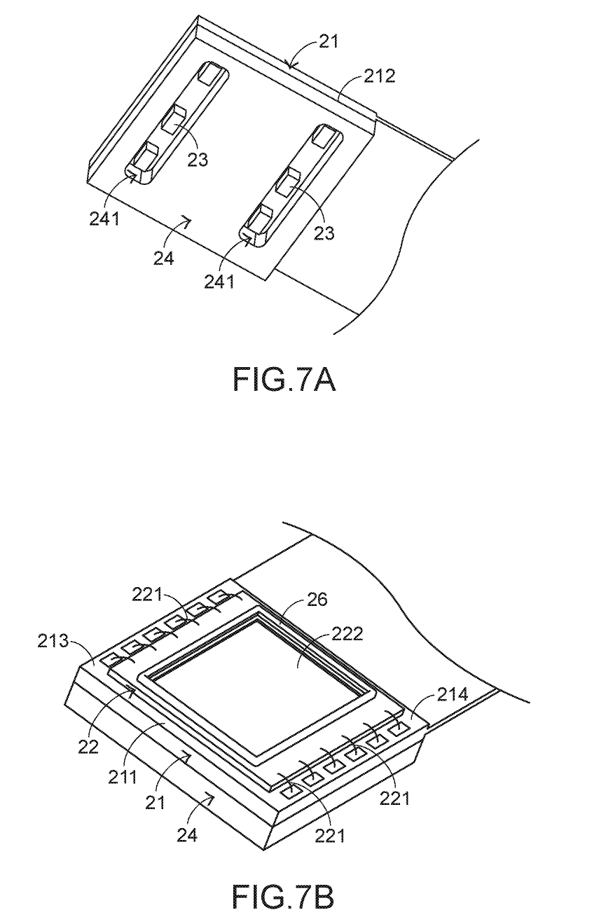

An assembling method of the camera module will be illustrated as follows. FIG. 6 is a flowchart illustrating an assembling method of a camera module according to an embodiment of the present invention. The assembling method comprises the following steps.

In a step A, plural electronic components are installed on a second surface of a substrate. In a step B, the second surface of the substrate is covered by a base plate. In a step C, a sensing chip is installed on a first surface of the substrate. In a step D, the first surface of the substrate is covered by a lens module. Consequently, the camera module is assembled.

The step D comprises the steps D1, D2, D3 and D4. In the step D1, a first glue is coated on a periphery region around a sensing region of the sensing chip. In the step D2, the first surface of the substrate is covered by a lens holder of the lens module. In the step D3, a second glue is coated in a gap between the substrate and the lens holder. In a step D4, a lens assembly of the lens module is installed on the lens holder.

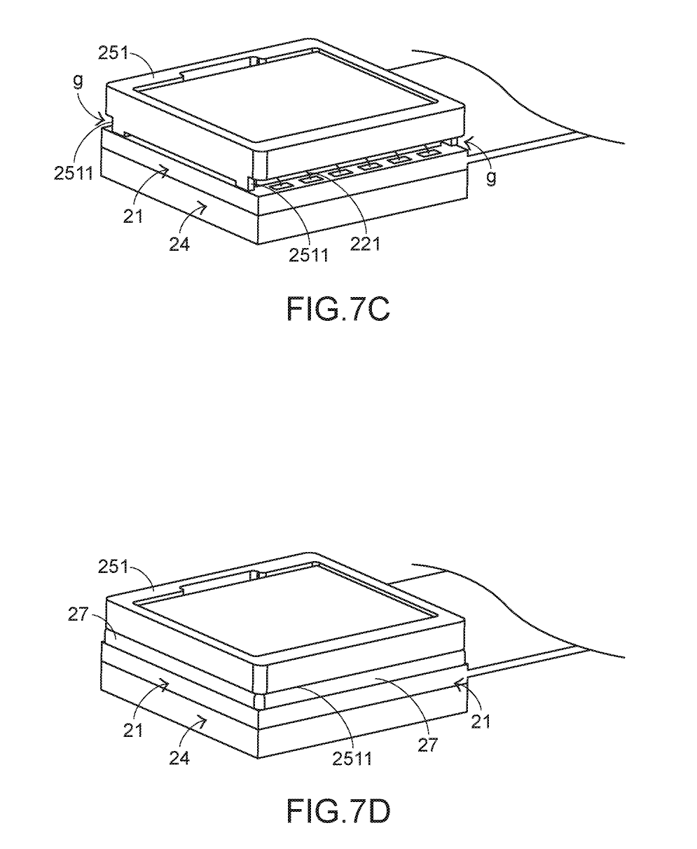

An implementation example of the assembling method of the camera module will be illustrated in more details as follows. FIGS. 7A˜7D schematically illustrate the steps of assembling the camera module of the present invention. Please refer to FIGS. 6 and 7A˜7D. After the assembling method of the camera module 2 is started, the step A is performed to install the plural electronic component 23 on the second surface 212 of the substrate 21. Preferably, the plural electronic component 23 are installed on the second surface 212 of the substrate 21 through a surface mount technology (SMT), and the plural electronic component 23 are electrically connected with the substrate 21. Then, in the step B, the second surface 212 of the substrate 21 is covered by the base plate 24, and the plural electronic components 23 are penetrated through the corresponding openings 241 of the base plate 24 and received within the base plate 24. Similarly, the base plate 24 is installed on the second surface 212 of the substrate 21 through the surface mount technology (SMT). Meanwhile, the combination of the substrate 21, the base plate 24 and the plural electronic components 23 is shown in FIG. 7A.

After the base plate 24 and the substrate 21 are combined together, the step C is performed. In the step C, the sensing chip 22 is installed on the first surface 211 of the substrate 21 and the plural welding parts 221 of the sensing chip 22 are electrically connected with the substrate 21. The combination of the sensing chip 22 and the substrate 21 is shown in FIG. 7B. As shown in FIG. 7B, the plural welding parts 221 are disposed on a first edge 213 of the substrate 21 and a third edge 214 of the substrate 21. Then, the step D1 is performed to coat the first glue 26 on the periphery region around the sensing region 222 of the sensing chip 22 (see also FIG. 7B).

After the first glue 26 is coated, the first surface 211 of the substrate 21 is covered by the lens holder 251 of the lens module 25. That is, the step D2 is performed. Consequently, the lens holder 251 is partially adhered onto the sensing chip 22 through the first glue 26. The combination of the lens holder 251 and the substrate 21 is shown in FIG. 7C. Meanwhile, plural gaps g are formed between the plural concave structures 2511 of the lens holder 251 and the first edge 213 and the third edge 214 of the substrate 21. Then, the step D3 is performed to coat the second glue 27 in the gaps g between the substrate 21 and the lens holder 251 (see FIG. 7D). Since the welding parts 221 are partially covered by the second glue 27, the efficacy of fixing the welding parts 221 is enhanced. Moreover, the space between the lens holder 251 and the substrate 21 is sealed by the second glue 27. Consequently, the external dust is prevented from entering the inside of the camera module 2 to contact with the sensing chip 22.

Afterwards, the step D4 is performed to install the lens assembly 252 of the lens module 25 on the lens holder 251. Consequently, the camera module 2 is assembled (see FIG. 5). As shown in FIG. 5, the third glue 28 is arranged between the lens holder 251 and the lens assembly 252. Consequently, the lens holder 251 and the lens assembly 252 are combined together. Preferably, in the step D4, the lens assembly 252 is fixed on the lens holder 251 through an active alignment technology.

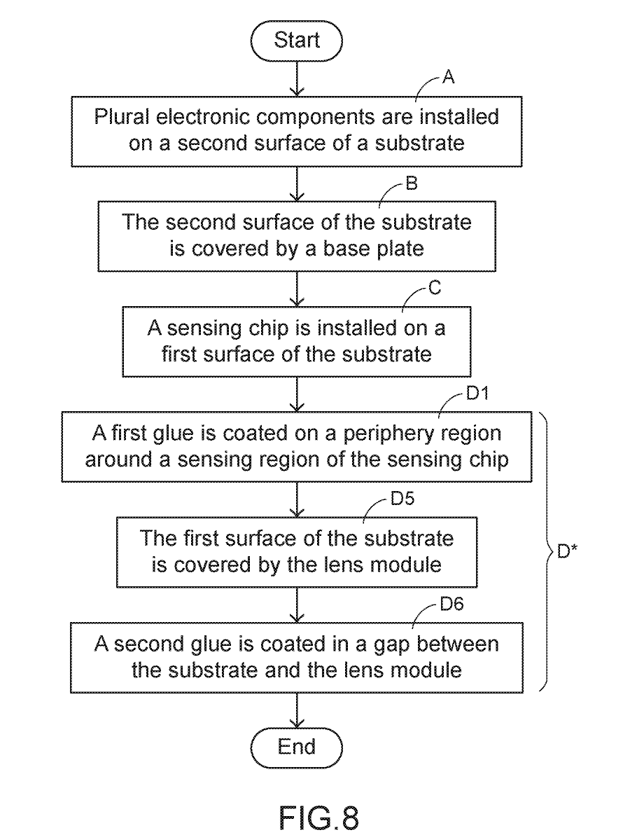

In another embodiment of the camera module, the lens holder and the lens assembly of the lens module are integrally formed. Consequently, the assembling method of the camera module is somewhat different. FIG. 8 is a flowchart illustrating an assembling method of a camera module according to another embodiment of the present invention. The assembling method comprises the following steps.

In a step A, plural electronic components are installed on a second surface of a substrate. In a step B, the second surface of the substrate is covered by a base plate. In a step C, a sensing chip is installed on a first surface of the substrate. In a step D*, the first surface of the substrate is covered by a lens module. Consequently, the camera module is assembled

The step D* comprises the steps D1, D5 and D6. In the step D1, a first glue is coated on a periphery region around a sensing region of the sensing chip. In the step D5, the first surface of the substrate is covered by the lens module. In the step D6, a second glue is coated in a gap between the substrate and the lens module.

Except for the following aspects, the assembling method of this embodiment is substantially identical to the assembling method of the above embodiment. In comparison with the assembling method of the above embodiment, the step D* comprises the steps D1, D5 and D6 because the lens holder and the lens assembly of the lens module are integrally formed. That is, the step of assembling the lens assembly with the lens holder is omitted.

From the above descriptions, the present invention provides an assembling method of a camera module. In accordance with the present invention, the plural electronic components are installed on the second surface of the substrate. In comparison with the conventional technology of installing the electronic components on the first surface of the substrate, the substrate used in the camera module of the present invention has smaller volume. Since the volume of the camera module is reduced, the camera module is slim. Moreover, in the assembling method of the present invention, the glue is coated in the gap between the lens holder and the substrate to seal the lens holder and the substrate. Moreover, since the sensing chip is partially covered by the glue, the electric connection between the substrate and the sensing chip is stabilized.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A camera module, comprising:
a substrate;
a sensing chip disposed on a first surface of the substrate and electrically connected with the substrate;
an electronic component disposed on a second surface of the substrate;
a base plate covering the second surface of the substrate, wherein the base plate comprises an opening, and the electronic component is received within the base plate through the opening; and
a lens module covering the first surface of the substrate, wherein the electronic component is not covered by the lens module.

2. The camera module according to claim 1, wherein the sensing chip further comprises a welding part, and the welding part is electrically connected with the substrate through a bonding wire.

3. The camera module according to claim 2, wherein the lens module comprises:
a lens holder covering the first surface of the substrate; and
a lens assembly disposed on the lens holder, wherein a concave structure is formed in a bottom surface of the lens holder, and the welding part is accommodated within the concave structure.

4. The camera module according to claim 3, further comprising a glue, wherein the glue is arranged between the concave structure and the substrate, a portion of the welding part is covered by the glue, and a space between the lens holder and the substrate is sealed by the glue.

5. The camera module according to claim 1, wherein the electronic component and the base plate are installed on the second surface of the substrate through a surface mount technology.

6. A camera module, comprising:
a substrate;
a sensing chip disposed on a first surface of the substrate, wherein the sensing chip comprises a welding part, and the welding part is electrically connected with the substrate;
a lens module covering the first surface of the substrate, wherein the lens module comprises a concave structure, and the welding part is accommodated within the concave structure; and
a glue arranged between the concave structure and the substrate, wherein a portion of the welding part is covered by the glue, and a space between the lens module and the substrate is sealed by the glue.

7. The camera module according to claim 6, further comprising:
an electronic component disposed on a second surface of the substrate; and
a base plate covering the second surface of the substrate, wherein the base plate comprises an opening, and the electronic component is received within the base plate through the opening, wherein the electronic component is not covered by the lens module.

8. The camera module according to claim 6, wherein the lens module comprises:
a lens holder covering the first surface of the substrate; and
a lens assembly disposed on the lens holder, wherein the concave structure is formed in a bottom surface of the lens holder.

9. An assembling method of a camera module, the assembling method comprising steps of:
(A) installing an electronic component on a second surface of a substrate;
(B) allowing a base plate to cover the second surface of the substrate;
(C) installing a sensing chip on a first surface of the substrate; and
(D) allowing a lens module to cover the first surface of the substrate, so that the camera module is assembled.

10. The assembling method according to claim 9, wherein in the step (A), the electronic component is installed on the second surface of the substrate through a surface mount technology.

11. The assembling method according to claim 9, wherein the base plate further comprises an opening, wherein in the step (B), the base plate is installed on the second surface of the substrate through a surface mount technology, and the electronic component is received within the base plate through the opening.

12. The assembling method according to claim 9, wherein the sensing chip further comprises a welding part, wherein in the step (C), the welding part of the sensing chip is electrically connected with the surface through a bonding wire.

13. The assembling method according to claim 12, wherein the step (D) comprises:
(D1) coating a first glue on a periphery region around a sensing region of the sensing chip;
(D2) allowing a lens holder of the lens module to cover the first surface of the substrate;
(D3) coating a second glue in a gap between the substrate and the lens holder, wherein a portion of the welding part is covered by the second glue, and a space between the lens holder and the substrate is sealed by the second glue; and
(D4) installing a lens assembly of the lens module on the lens holder.

14. The assembling method according to claim 12, wherein the step (D) comprises:
(D1) coating a first glue on a periphery region around a sensing region of the sensing chip;
(D5) allowing the lens module to cover the first surface of the substrate; and
(D6) coating a second glue in a gap between the substrate and the lens module, wherein a portion of the welding part is covered by the second glue, and the camera module is sealed by the second glue.
